(19) United States
(12) Patent Application Publication
(10) Pub. No.: US 2025/0027546 A1
(43) Pub. Date: Jan. 23, 2025

(54) CALIPER BRAKE

(71) Applicant: HL MANDO CORPORATION, Gyeonggi-do (KR)

(72) Inventor: Dongkyun AHN, Seoul (KR)

(21) Appl. No.: 18/757,368

(22) Filed: Jun. 27, 2024

(30) Foreign Application Priority Data
Jul. 18, 2023 (KR) 10-2023-0093011

(51) Int. Cl. F16D 65/00; F16D 55/00; F16D 55/226

(52) U.S. Cl. CPC F16D 65/0031; F16D 55/226; F16D 65/0068; F16D 2055/0016

(57) ABSTRACT

A caliper brake, including a disc configured to be rotatable with a wheel and a pair of brake pads disposed at both sides of the disc, may include a caliper housing in which at least a part of the brake pads is disposed and which covers at least a part of the disc and a dust capturing device configured to capture dust caused by the disc and the brake pads in contact with each other. The dust capturing device may include a filter housing disposed to face an outer circumferential surface of the disc and a filter module coupled to the filter housing. The filter module may be snap-coupled to a filter accommodation part provided at the filter housing. And, the filter module and the filter housing may have a slide-coupling to be coupled to each other.

### CROSS-REFERENCE TO RELATED APPLICATION

This application claims the benefit of and priority to Korean Patent Application No. 10-2023-0093011, filed on Jul. 18, 2023 in the Korean Intellectual Property Office, the disclosure of which is incorporated herein by reference in its entirety.

### BACKGROUND

### 1. Field

Embodiments of the present disclosure generally relate to a caliper brake, and more specifically, to a caliper brake which can stably capture dust caused by friction between a brake pad and a disc and improve easiness of maintenance.

### 2. Description of the Related Art

Nowadays, eco-friendliness is emerging as an important issue in a vehicle industry as the importance of protecting the environment is highlighted, and regulations on pollutants discharged from vehicles are also continuously being more strict.

The pollutants discharged from vehicles may be categorized into pollutants discharged from exhaust systems and pollutants discharged from non-exhaust systems. The pollutants discharged from the exhaust systems have been regulated as pollutants contained in exhaust gases generated during the engine operation of the vehicle, and it is expected that regulations on the pollutants discharged from the non-exhaust systems will also be legislated in recent years.

The most typical pollutant discharged from the non-exhaust systems is dust generated by a brake system. Specifically, in a disc brake which is the brake system mounted on a vehicle, brake pads are in contact with and pressed against both sides of a disc which rotates with a wheel to obtain a braking force by friction or a clamping pressure between the disc and the brake pads. In this case, dust is generated due to abrasion by friction between the disc and a brake paddle which is known to contain a large amount of components harmful to the human body.

In addition, monoblock caliper brakes having high rigidity and braking force have been developed and applied to high-performance vehicles. In such a monoblock caliper brake, since friction or a clamping pressure between the disc and the brake pads further increases, an amount of dust generated may increase further.

Accordingly, dust or fine dust generated from a brake system may need to be effectively captured or collected and the maintenance for the dust by a user such as a driver may need to be easily performed.

### SUMMARY

Therefore, it is an aspect of the present disclosure to provide a caliper brake capable of capturing dust generated by friction between a disc and a brake pad.

It is another aspect of the present disclosure to provide a caliper brake capable of suppressing and minimizing external spread of dust generated by friction between a disc and a brake pad.

It is still another aspect of the present disclosure to provide the easiness of the maintenance of a caliper brake because a filter module is detachably attached to the caliper brake.

It is still another aspect of the present disclosure to provide a caliper brake capable of improving marketability and competitiveness.

It is still another aspect of the present disclosure to provide a caliper brake having a simple structure to improve productivity and assemblability of a product.

In accordance with one aspect of the present disclosure, a caliper brake, which includes a disc rotated with a wheel and a pair of brake pads disposed at both sides of the disc, includes a caliper housing in which the brake pads are disposed and which surrounds at least a part of the disc and a dust capturing device configured to capture dust generated by the disc and the brake pads in contact with each other, wherein the dust capturing device includes a filter housing disposed to face an outer circumferential surface of the disc and a filter module coupled to the filter housing, and the filter module is snap-coupled to a filter accommodation part provided in the filter housing.

The filter module may include a filter member and a cage in which the filter member is supported.

At least one clip may be formed to protrude outward from the cage, and a clip groove where the clip is inserted and fastened may be formed to be recessed in the filter housing.

The clip may be formed on a side end portion of the cage, and the clip groove may be formed in a side end portion of the filter housing.

The filter accommodation part may be formed to be recessed in or pass through a central portion of the filter housing in a radial direction.

A plurality of flow holes may be formed to pass through the cage.

The cage may include a first cage forming an outer surface of the cage in a radial direction and a second cage forming an inner surface of the cage in the radial direction, and the filter member may be accommodated between the first cage and the second cage.

The first cage and the second cage may be snap-coupled.

At least one cage clip may be formed to protrude from any one of the first cage and the second cage, and a cage clip groove where the cage clip is inserted and fastened may be formed to be recessed in the other of the first cage and the second cage.

A plurality of flow holes may be formed to pass through each of the first cage and the second cage.

The filter housing may be supported by a fixing part of a vehicle body.

The fixing part may be formed as a knuckle.

The filter housing may include a first filter housing disposed inside the vehicle body and the second filter housing disposed outside the vehicle body, and the first filter housing and the second filter housing may be formed to extend toward a leading part and a trailing part of the caliper housing.

At least one of the first filter housing and the second filter housing may include a maintenance hole formed to be open so that a part of an outer surface of the caliper housing is exposed outward.

The filter accommodation part and the filter module may be provided as a plurality of filter accommodation parts and a plurality of filter modules, respectively.

In accordance with another aspect of the present disclosure, a caliper brake, which includes a disc rotated with a wheel and a pair of brake pads disposed at both sides of the disc, includes a caliper housing in which the brake pads are disposed and which surrounds at least a part of the disc i and a dust capturing device configured to capture dust generated by the disc and the brake pads in contact with each other, wherein the dust capturing device includes a filter housing disposed to face an outer circumferential surface of the disc and a filter module coupled to the filter housing, and the filter module is slidably coupled to a filter accommodation part provided in the filter housing.

The filter module may include a filter member and a cage in which the filter member is supported.

The cage may include a slide groove formed to be recessed therein to allow an edge of the filter accommodation part to be inserted into and moved in the slide groove.

The filter housing may include a first filter housing disposed inside a vehicle body and a second filter housing disposed outside the vehicle body, the filter accommodation part may be formed in each of the first filter housing and the second filter housing, at least a part of the slide groove may be is coupled to an edge of the filter accommodation part formed in any one of the first filter housing and the second filter housing, and the remaining part may be coupled to an edge of the filter accommodation part formed in the other of the first filter housing and the second filter housing.

The filter housing may include a first filter housing disposed inside the vehicle body and a second filter housing disposed outside the vehicle body, the filter accommodation part may be formed in the second filter housing, the slide groove may be coupled to the edge of the filter accommodation part of the second filter housing, and the second filter housing may be coupled to and supported by the first filter housing.

The slide groove may be formed to extend in an axial direction of the disc.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a front view illustrating a caliper brake to or on which a dust capturing device is mounted according to an embodiment of the present disclosure;

FIG. 2 is a rear view illustrating the caliper brake to or on which a dust capturing device is mounted according to an embodiment of the present disclosure;

FIG. 3 is a perspective view illustrating the caliper brake to or on which a dust capturing device is mounted according to an embodiment of the present disclosure;

FIG. 4 is an exploded perspective view illustrating a filter housing according to an embodiment of the present disclosure;

FIG. 5 is an exploded perspective view illustrating a cage according to an embodiment of the present disclosure;

FIG. 6 is a cross-sectional view illustrating a filter module according to an embodiment of the present disclosure;

FIG. 7 is an exploded perspective view illustrating a dust capturing device according to an embodiment of the present disclosure;

FIG. 8 is a perspective view illustrating a dust capturing device according to another embodiment of the present disclosure;

FIG. 9 is an exploded perspective view illustrating a dust capturing device according to another embodiment of the present disclosure;

FIG. 10 is a cross-sectional view illustrating a dust capturing device according to another embodiment of the present disclosure;

FIG. 11 is a perspective view illustrating a caliper brake to or on which a dust capturing device is mounted according to still another embodiment of the present disclosure; and

FIG. 12 is a rear view illustrating a caliper brake to or on which the dust capturing device is mounted according to still another embodiment of the present disclosure.

### DETAILED DESCRIPTION

Hereinafter, embodiments of the present disclosure will be described in detail with reference to the accompanying drawings. The following embodiments are to provide the spirit of the present disclosure to those skilled in the art. The present disclosure is not limited to the embodiments disclosed herein and may be implemented in different forms. In the drawings, portions which are not related to the description may be omitted for clarifying the present disclosure, and sizes of components may be exaggerated for facilitating understanding of the present disclosure.

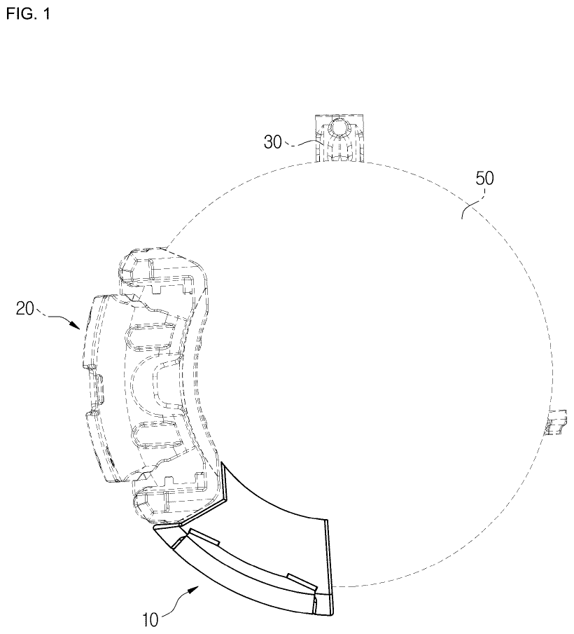

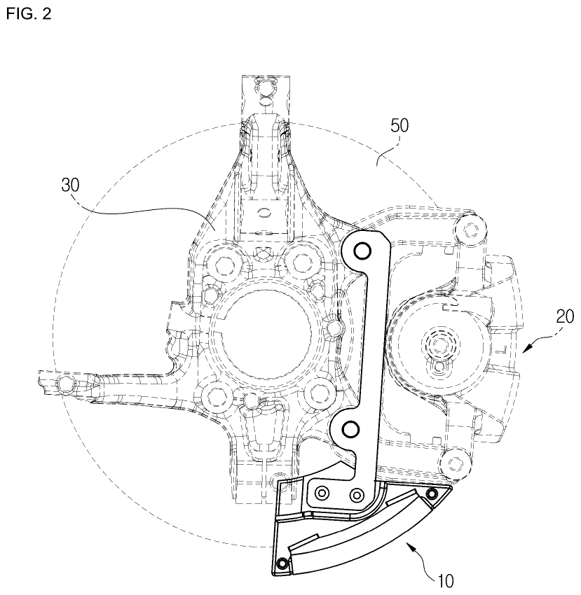

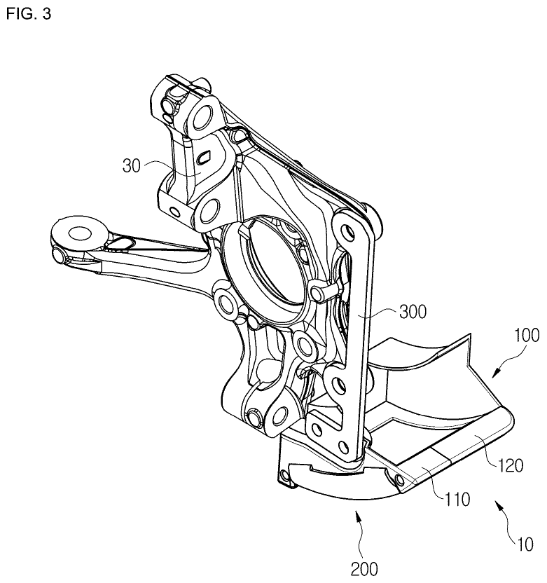

FIG. 1 is a front view illustrating a caliper brake on which a dust capturing device is mounted according to an embodiment of the present disclosure, and FIGS. 2 and 3 are a rear view and a perspective view, respectively, illustrating the caliper brake on which the dust capturing device is mounted according to an embodiment of the present disclosure.

Referring to FIGS. 1 to 3, the caliper brake according to the present embodiment may include a brake disc 50 which rotates with a wheel of a vehicle, a pair of brake pads disposed at or on both sides of the disc, a carrier fixedly installed on or at a vehicle body, a caliper housing 20 in which the brake pads are disposed and which is provided to be slidable with respect to the carrier, a pressing member installed on the caliper housing 20 to move forward or backward, and a dust capturing device 10 configured to capture dust caused or generated by the disc and the brake pads by being in contact with each other.

The brake disc 50 is configured to rotatable together with the wheel of the vehicle, and an inner brake pad and an outer brake pad are disposed at or on both sides of the disc. The inner brake pad and the outer brake pad are fixedly installed on an inner pad plate and an outer pad plate, and the brake pads are attached to inner surfaces (i.e. surfaces facing the brake disc) of the pad plates. An outer side surface of the inner pad plate is disposed to be in contact with the pressing member such as a piston, and the outer pad plate is installed on an inner rear surface of the caliper housing 20, which will be described below, with the outer brake pad. Accordingly, when the vehicle performs braking operations, the pressing member moves forward to press the inner pad plate and the inner brake pad toward the brake disc so that the inner pad plate and the inner brake pad are in close contact with the brake disc, and due to a reaction of the pressure, the caliper housing 20 may slide with respect to the carrier fixedly installed on the vehicle body in a direction opposite to a forward direction of the pressing member so that the outer pad plate and the outer brake pad installed in the caliper housing 20 may be pressed against and be in close contact with the brake disc.

For example, the pressing member may be provided as the piston and may be configured to be movable forward or backward in a cylinder provided in the caliper housing 20. The pressing member may be moved forward or backward by a hydraulic pressure of a pressing medium such as a brake oil or a mechanical force to brake the vehicle or moved forward by receiving power from a motor to brake the vehicle. In addition, the pressing member may move backward to release the braking of the vehicle when the hydraulic pressure of the pressing medium is released or move backward by receiving power from the motor to release the braking or a parking brake state of the vehicle.

The caliper housing 20 may include the cylinder in which the piston is disposed to be movable forward or backward, and the brake pads are disposed inside the caliper housing 20. The caliper housing 20 may be connected to and supported by the carrier through a guide member and may also be slidable with respect to the carrier by the guide member in forward and backward directions. The dust capturing device, which will be described below, may be provided on, for instance, but not limited to, at least any one of a leading part and a trailing part of the caliper housing 20, and a detailed description thereof will be described below.

The dust capturing device 10 is provided around the disc 50 or disposed around or coupled to the caliper housing 20 of the caliper brake to capture dust caused or generated by the disc and the brake pads in contact with each other in order to suppress and minimize the spread of hazardous substances.

Referring to FIGS. 1 to 3, the dust capturing device 10 according to the present embodiment may include a filter housing 100, a filter module 200, and a bracket 300. At least a part of the filter housing 100 may be disposed to face or cover an outer circumferential surface of the disc 50. The filter module 200 may be coupled to the filter housing 100. One side of an end portion of the bracket 300 may be mounted to a fixing part of the vehicle body, a fixture or a part of the vehicle or a body of the vehicle and the other side of the bracket 300 may be coupled to the filter housing 100.

At least a part of the filter housing 100 is disposed to face the outer circumferential surface of the disc 50. For example, the filter housing 100 is disposed to be spaced apart from the outer circumferential surface of the disc 50 in a radial direction of the disc 50, a cross section of the filter housing 100 may be substantially “U” or “V” shaped and surround at least a part of an outer side of the outer circumferential surface of the disc 50 in the radial direction and at least a part of a front surface and a rear surface of the disc 50 around the caliper housing 20, and the filter housing 100 may have an outer circumferential surface facing the outer circumferential surface of the disc 50 and a sidewall surface facing the front surface and the rear surface of the disc 50. The filter housing 100 may be divided into a first filter housing 110 and a second filter housing 120 and may be formed by separate pieces, the first filter housing 110 and the second filter housing 120, and detailed descriptions thereof will be described below.

In addition, the filter module 200 may be coupled to and supported by the filter housing 100, and the filter housing 100 may be mounted on or to the vehicle by the bracket 300. One side of the bracket 300 may be mounted on or to a fixing part of the vehicle body, a fixture or a part of the vehicle or a body of the vehicle, and the other side of the bracket 300 may be connected and coupled to the filter housing 100. For instance, the fixing part of the vehicle body may be a knuckle 30 on or to which the caliper housing 20 is mounted as illustrated in FIGS. 1 to 3, although not required. As the bracket 300 is fixedly mounted on or to the knuckle 30 of the vehicle body, the filter housing 100 may be positioned in a portion adjacent to the caliper housing 20 or the disc 50.

Hereinafter, the dust capturing device 10 according to some embodiments of the present disclosure will be described in detail.

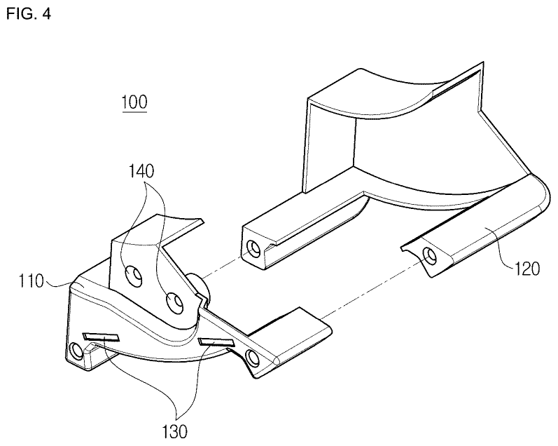

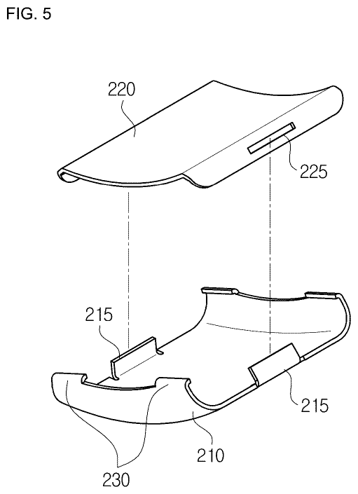

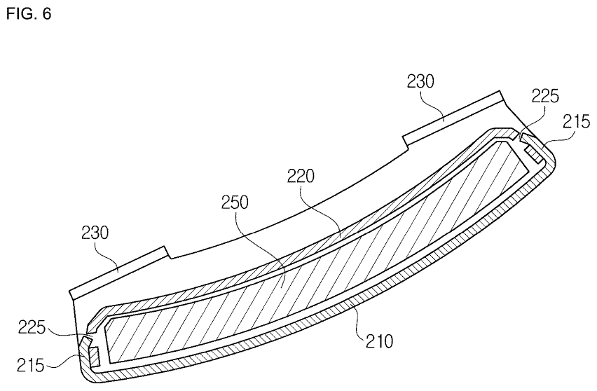

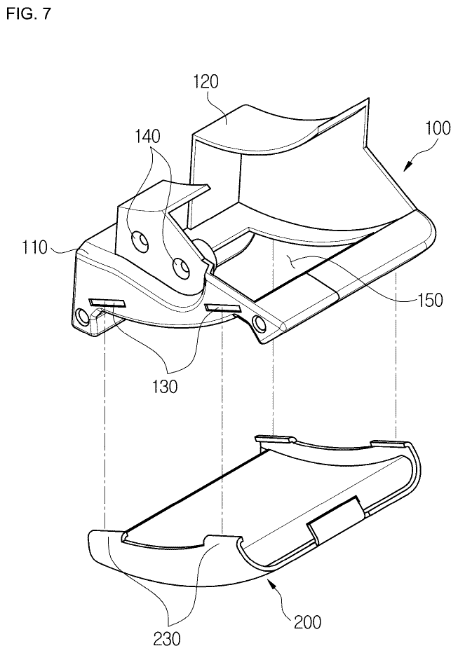

FIG. 4 is an exploded perspective view illustrating the filter housing according to an embodiment of the present disclosure, FIG. 5 is an exploded perspective view illustrating a cage according to an embodiment of the present disclosure, FIG. 6 is a cross-sectional view illustrating the filter module according to an embodiment of the present disclosure, and FIG. 7 is an exploded perspective view illustrating the dust capturing device according to an embodiment of the present disclosure.

Referring to FIG. 4, the filter housing 100 may include the first filter housing 110 and the second filter housing 120. At least a part of the first filter housing 110 may be disposed inside the vehicle body and at least a part of the second filter housing 120 may be disposed outside the vehicle body.

The first filter housing 110 disposed inside the vehicle body may include an inner wall surface facing an inner surface of the disc 50 and an outer circumferential surface facing the outer circumferential surface of the disc 50. The second filter housing 120 disposed outside the vehicle body may include an outer wall surface facing an outer surface of the disc 50 and an outer circumferential surface facing the outer circumferential surface of the disc 50. The first filter housing 110 and the second filter housing 120 may be coupled to each other to form a body such as a single piece body in which the filter module 200 is accommodated and supported and formed in a shape of surrounding or covering at least a part of an inner surface, an outer surface, and an outer circumferential surface of the disc 50. In addition, the first filter housing 110 and the second filter housing 120 may be substantially arc-shaped and have a shape corresponding to a shape of the disc 50.

The filter housing 100 may be mounted on or to the vehicle by or through the bracket 300. To this end, a bracket coupling hole 140 to which the bracket 300 is mounted and coupled using a fastening member or fastener such as a bolt may be provided in the first filter housing 110, and the second filter housing 120 may be coupled to the first filter housing 110 to be mounted on the vehicle. The first filter housing 110 and the second filter housing 120 may be coupled to each other using a fastening member or fastener such as a bolt.

The filter module 200 is provided to be coupled to and supported by the filter housing 100 to filter dust caused or generated by the disc and the brake pads in contact with each other. Referring to FIGS. 5 and 6, the filter module 200 may include a filter member 250 having a filter and a cage configured to support the filter member 250.

The filter member 250 having the filter may receive air containing the dust caused or generated by the disc and the brake pads in contact with each other to capture the dust and discharge the air, from which the dust is filtered, to the outside of the filter member 250. The filter member 250 may be located or accommodated and supported in the cage, and the cage may form an exterior of the filter module 200 and allow the filter member 250 to be detachably attached to the filter housing 100. The filter member 250 and the cage may be substantially arc-shaped and have a shape corresponding to a shape of the disc 50.

The cage may include a first cage part 210 forming an outer side surface in a radial direction of the disc 50 and a second cage part 220 forming an inner surface in a radial direction. The first cage part 210 and the second cage part 220 may be provided to be detachably attached to each other, and the first cage part 210 and the second cage part 220 may form an inner accommodation space for accommodating the filter member 250 between the first cage part 210 and the second cage part 220.

For example, the first cage part 210 and the second cage part 220 may be snap-coupled to each other. Specifically, cage clips 215 may be formed on or at a front end portion and a rear end portion (or any end portion) of the first cage part 210 and have a shape of being bent or protruding from the first cage part 210, and cage clip grooves 225 into which the cage clips 215 are inserted may be formed in or at a front end portion and a rear end portion (or any end portion) of the second cage part 220 and be formed as a hole passing through the second cage part 220 or a recess recessed from the a surface of the second cage part 220. The cage clips 215 may be configured to be elastically deformable to be snap-coupled such that parts of the cage clips 215 are deformed when the cage clips 215 are being inserted into the cage clip grooves 225. Accordingly, the cage clips 215 may be inserted into and snap-coupled to the cage clip grooves 225 so that the first cage part 210 and the second cage part 220 may be coupled to each other.

As described above, as the cage clips 215 are integrally formed with the first cage part 210 by having a shape of being bent or protruding from the first cage part 210, and the cage clip grooves 225 are integrally formed with the second cage part 220 as a hole passing through the second cage part 220 or a recess recessed from a surface of the second cage part 220, the first cage part 210 and the second cage part 220 may be directly snap-coupled without a separate fastening member, and thus a structure can be simplified, and smooth maintenance such as easy replacement of the filter member 250 can be performed. Alternatively, the first cage part 210 may have cage clip grooves and the second cage part 220 may have cage clips. However, the first cage part 210 and the second cage part 200 can be coupled by any means which is capable of separably coupling or connecting the first cage part 210 and the second cage part 200.

The filter member 250 having a filter may capture or filter dust contained in air. For instance, a plurality of flow holes may be formed to pass through the cage so that air containing dust smoothly can approach the filter member 250, pass through the flow holes and be discharged from the filter member 250. Specifically, the air containing the dust may smoothly approach the filter member 250 through the plurality of flow holes provided in the second cage part 220, and the air from which the dust is filtered may be discharged to the outside of the filter member 250 through the plurality of flow holes provided in the first cage part 210. The flow holes may be formed in any of various shapes as long as the inside and the outside of the cage can communicate with each other and air can be flowed therethrough. As an example, the flow holes may be provided in the form of a plurality of slits or nets, or in the form of a plurality of circular holes that are regularly arranged, and in addition, at least some of the circular holes may be formed to pass through the cage to be inclined to smoothly guide an air.

Referring to FIG. 7, the filter module 200 in which the filter member 250 having a filter is accommodated and mounted may be coupled to a filter accommodation part 150 formed in the filter housing 100.

The filter accommodation part 150 may be formed in a central portion of the filter housing 100 to be recessed in or pass through the filter housing 100 in a radial direction of the disc 50. The filter module 200 may be coupled to and supported by the filter accommodation part 150 of the filter housing 100. For example, the filter module 200 may be snap-coupled to the filter accommodation part 150 of the filter housing 100. To this end, clips 230 formed to protrude from both end portions of the cage of the filter module 200 are provided, and clip grooves 130 may be formed to be recessed in or pass through a portion of the filter housing 100 adjacent to the filter accommodation part 150. The clips 230 may be configured to be elastically deformable such that at least parts of the clips 230 can be deformed to be snap-coupled when the clips 230 are inserted into the clip grooves 130. A plurality of clips 230 and a plurality of clip grooves 130 may be provided for stable coupling of the filter housing 100 and the filter module 200.

As described above, the clips 230 are integrally formed with the cage to be bent or protrude, and the clip grooves 130 are integrally formed to pass through the filter housing 100 or be recessed from a surface of the filter housing 100, the filter module 200 may be directly snap-coupled to the filter housing 100 without a separate fastening member, and thus the structure is simplified, and smooth maintenance such as easy replacement of the filter module 200 can be performed. Alternatively, the filter housing 100 may have clips and the filter module 200 may have clip grooves.

Meanwhile, in FIGS. 1 to 7, it is illustrated that one filter accommodation part 150 is provided in one filter housing 100, and one filter module 200 is installed in the filter accommodation part 150, but the present disclosure not limited thereto. Two or more filter accommodation part can be included in the filter housing 100 and two or more filter modules 200 may be mounted to the filter accommodation part 150 and it should be equally understood even when a plurality of filter accommodation parts 150 are provided in one filter housing 100, and a plurality of filter modules 200 are snap-coupled to and mounted on the filter accommodation part 150. By having a plurality of filter modules 200 mounted on the filter accommodation part 150, the filter modules 200 can be independently replaced depending on the degree of contamination.

Hereinafter, a dust capturing device 10 according to a second embodiment of the present disclosure will be described.

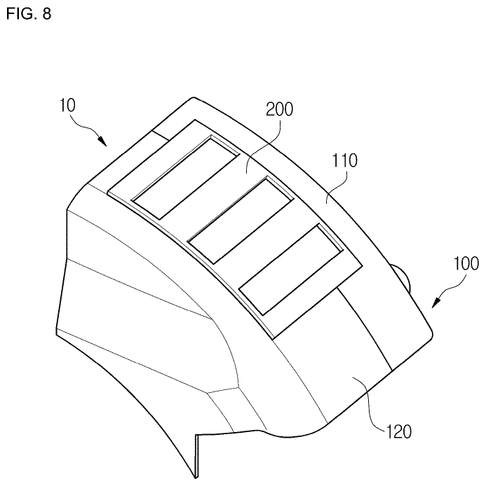

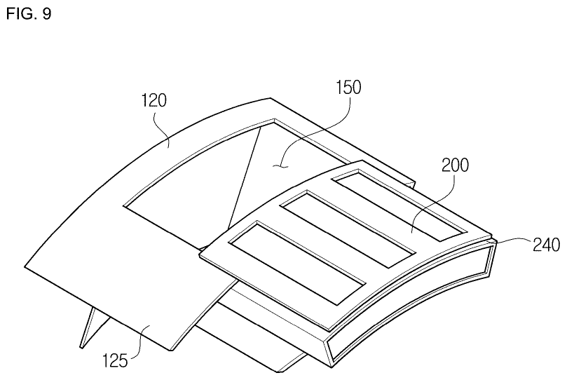

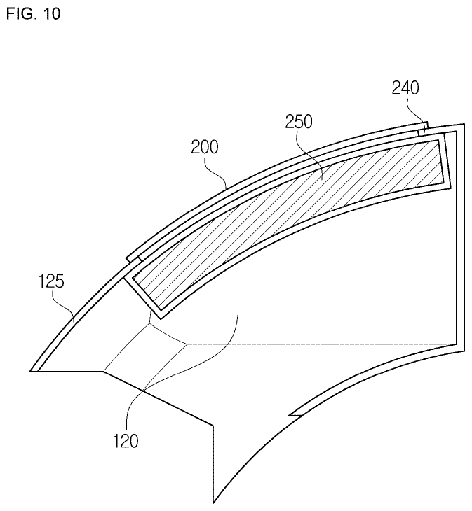

FIG. 8 is a perspective view illustrating a dust capturing device according to the second embodiment of the present disclosure, FIG. 9 is an exploded perspective view for illustrating the dust capturing device according to the second embodiment of the present disclosure, and FIG. 10 is a cross-sectional view for illustrating the dust capturing device according to the second embodiment of the present disclosure.

Referring to FIGS. 8 to 10, the dust capturing device 10 according to the second embodiment of the present disclosure may include a filter housing 100, a filter module 200, and a bracket 300. At least a part of the filter housing 100 may be disposed to face an outer circumferential surface of the disc 50. The filter module 200 may be coupled to the filter housing 100. One side of an end portion of the bracket 300 may be mounted on a fixing part of a vehicle body, a fixture or a part of the vehicle or a body of the vehicle, and the other side of the bracket 300 is coupled to the filter housing 100.

Since some of the structures, functions and operations of the second embodiment of the present disclosure, which will be described below, are the same as or similar to those of the first embodiment of the present disclosure described above, certain descriptions of the second embodiment overlapped with the first embodiment will be omitted to prevent duplicated descriptions.

At least a part of the filter housing 100 is disposed to face the outer circumferential surface of the disc 50. For instance, the filter housing 100 is disposed to be spaced apart from the outer circumferential surface of the disc 50 in a radial direction of the disc 50, a cross-section of the filter housing 100 may be substantially “U” or “V” shaped and surround at least a part of an outer side of the outer circumferential surface of the disc 50 in the radial direction and a part of a front surface and a rear surface of the disc 50 around the caliper housing 20, and the filter housing 100 may have an outer circumferential surface facing the outer circumferential surface of the disc 50 and a sidewall surface facing the front surface and the rear surface of disc 50. The filter housing 100 may be divided into a first filter housing 110 and a second filter housing 120 and may be formed by separate pieces, the first filter housing 110 and the second filter housing 120.

The filter module 200 may be coupled to and supported by the filter housing 100, and the filter housing 100 may be mounted on or to the vehicle by the bracket 300. One side of the bracket 300 may be mounted on or to a fixing part of the vehicle body such as a knuckle 30 of the vehicle body, a fixture or a part of the vehicle or a body of the vehicle, and the other side of the bracket 300 may be connected and coupled to the filter housing 100, and accordingly, the filter housing 100 may be disposed in a portion adjacent to the caliper housing 20 or the disc 50.

The first filter housing 110 may be disposed inside the vehicle body and include an inner wall surface facing an inner surface of the disc 50 and an outer circumferential surface facing the outer circumferential surface of the disc 50. The second filter housing 120 may be disposed outside the vehicle body and include an outer wall surface facing an outer surface of the disc 50 and an outer circumferential surface facing the outer circumferential surface of the disc 50. The first filter housing 110 and the second filter housing 120 may be coupled to each other to form a body such as a single piece body in which the filter module 200 is accommodated and supported and formed in a shape of surrounding or covering at least a part of an inner surface, an outer surface, and an outer circumferential surface of the disc 50. In addition, the first filter housing 110 and the second filter housing 120 may be arc-shaped and have a shape corresponding to a shape of the disc 50.

The filter housing 100 may be mounted on or to the vehicle by or through the bracket 300. To this end, a bracket coupling hole 140 to which the bracket 300 is mounted and coupled using a fastening member or fastener such as a bolt may be provided in the first filter housing 110, and the second filter housing 120 may be coupled to the first filter housing 110 to be mounted on the vehicle. The first filter housing 110 and the second filter housing 120 may be coupled to each other using a fastening member or fastener such as a bolt.

The filter module 200 may be provided to be coupled to and supported by the filter housing 100 to filter dust caused or generated by the disc and brake pads in contact with each other and coupled to a filter accommodation part 150 formed by coupling of the first filter housing 110 and the second filter housing 120.

In the dust capturing device 10 according to the second embodiment, as a part of the filter accommodation part 150 is formed in the first filter housing 110, and the remaining part of the filter accommodation part 150 is formed in the second filter housing 120, the filter accommodation part 150 may be divided by the coupling of the first filter housing 110 and the second filter housing 120. That is, a part of an edge of the filter accommodation part 150 may be formed in the first filter housing 110, and the remaining part of the edge of the filter accommodation part 150 may be formed in the second filter housing 120, and detailed descriptions thereof will be described below.

The filter module 200 may include a filter member 250 having a filter and a cage configured to support the filter member 250, and the filter member 250 may be slidably coupled to the filter accommodation part 150.

The filter member 250 having a filter may receive air containing dust caused or generated by the disc and the brake pads in contact with each other to capture the dust and discharge the air, from which the dust is filtered, to the outside of the filter member 250. The filter member 250 may be located or accommodated and supported in the cage, and the cage may form an exterior of the filter module 200 and allow the filter member 250 to be detachably attached to the filter housing 100. The filter member 250 and the cage may be substantially arc-shaped and have a shape corresponding to a shape of the disc 50.

The filter member 250 and the filter housing 100 may have slide-coupling to be coupled to each other. For instance, the filter member 250 may be located or accommodated and supported in the cage, and a slide groove 240 may be recessed from an outer surface of the cage so that the edge of the filter accommodation part 150 can be inserted into and moved in the slide groove 240.

As illustrated in FIGS. 9 and 10, the slide groove 240 may be recessed from an outer side surface of the cage and extend in an axial direction of the disc 50. As the edge of the filter accommodation part 150 provided in the first filter housing 110 and the second filter housing 120 is inserted into and moved in the slide groove 240, the filter housing 100 and the filter module 200 may be slidably coupled to each other. Specifically, as illustrated in FIG. 9, the slide groove 240 of the filter module 200 is slidably coupled to the edge of the filter accommodation part 150 formed in the second filter housing 120 in a state in which the first filter housing 110 and the second filter housing 120 are separated, then the first filter housing 110 and the second filter housing 120 are coupled to mount the filter module 200 in or to the filter housing 100 (see FIG. 8).

Alternatively, unlike the example described above, the filter accommodation part 150 may be provided in only one of the first filter housing 100 and the second filter housing 120. In another example, the filter accommodation part 150 may be provided only in the second filter housing 120, and one side of the second filter housing 120 may be open so that the filter module 200 can enter or be inserted into the second filter housing 120, and the slide groove 240 of the filter module 200 may be slidably coupled to the edge of the filter accommodation part 150 of the second filter housing 120. Then, the second filter housing 120 in or to which the filter module 200 is mounted may be coupled to the first filter housing 110 to be supported by or coupled to the vehicle.

As described above, as the slide groove 240 is integrally formed by being recessed from an outer surface of the cage of the filter module 200 and the edge of the filter accommodation part 150 is moved in, inserted into, and slidably coupled to the slide groove 240, the filter module 200 may be mounted and supported in or by the filter housing 100 without a separate fastening member or an additional fastener, and thus a structure can be simplified, and the filter module 200 can be easily replaced with another filter module.

Hereinafter, a dust capturing device 10 according to a third embodiment of the present disclosure will be described.

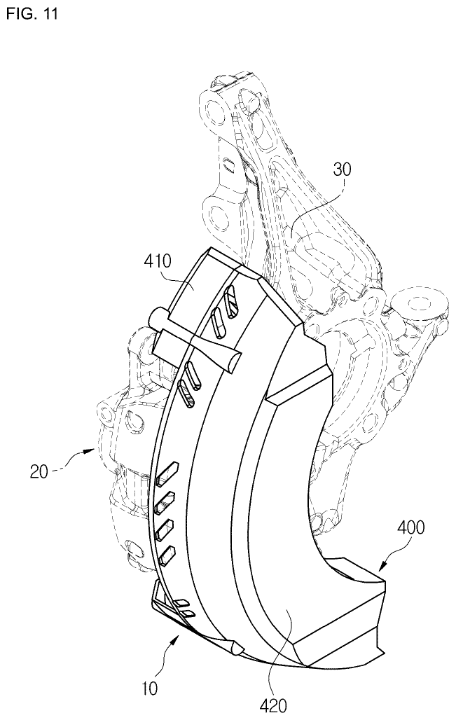

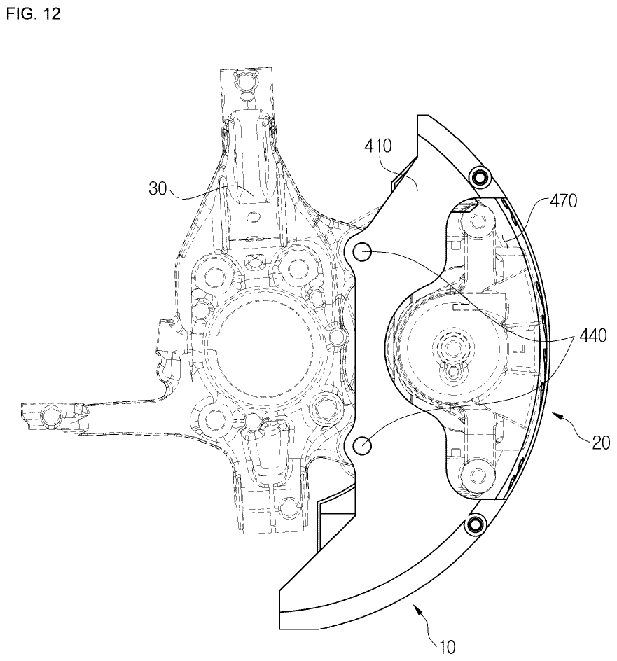

FIGS. 11 and 12 are a perspective view and a rear view illustrating a caliper brake to which a dust capturing device is mounted according to a third embodiment of the present disclosure.

Referring to FIGS. 11 and 12, a filter housing 400 of a dust capturing device 10 according to the third embodiment may include a first filter housing 410 and a second filter housing 420. At least a part of the first filter housing 410 may be disposed inside a vehicle body and at least a part of the second filter housing 420 may be disposed outside the vehicle body.

Since some of structures, functions and operations of the third embodiment of the present disclosure, which will be described below, are the same as or similar to those of the first and second embodiments of the present disclosure described above, certain descriptions of the third embodiment of the present disclosure overlapped with the first and second embodiments will be omitted to prevent duplicated descriptions.

At least a part of the filter housing 400 is disposed to face an outer circumferential surface of a disc 50. For instance, the filter housing 400 is disposed to be spaced apart from the outer circumferential surface of the disc 50 in a radial direction of the disc 50, a cross-section of the filter housing 400 may be substantially “U” or “V” shaped surround at least a part of an outer side of the outer circumferential surface of the disc 50 in the radial direction and at least a part of a front surface and a rear surface of the disc 50 around a caliper housing 20, and the filter housing 400 may have an outer circumferential surface facing the outer circumferential surface of the disc 50 and a sidewall surface facing the front surface and the rear surface of the disc 50. The filter housing 100 may be divided into a first filter housing 110 and a second filter housing 120 and may be formed by separate pieces, the first filter housing 110 and the second filter housing 120, and detailed descriptions thereof will be described below.

The filter housing 400 may be directly or indirectly mounted on or to a fixing part of the vehicle body, a fixture or a part of the vehicle or a body of the vehicle. For example, the fixing part of the vehicle body may be a knuckle 30 of the vehicle on or to which the caliper housing 20 is mounted as illustrated in FIG. 12, and a knuckle coupling hole 440 into which a fastening member or fastener such as a bolt is inserted may be provided in the first filter housing 410 which will described below.

The filter housing 400 may include the first filter housing 410 disposed inside the vehicle body and the second filter housing 420 disposed outside the vehicle body.

At least a part of the first filter housing 410 may be disposed inside the vehicle body and the first filter housing 410 may include an inner wall surface facing an inner surface of the disc 50 and an outer circumferential surface facing the outer circumferential surface of the disc 50. At least a part of the second filter housing 420 may be disposed outside the vehicle body and the second filter housing may include an outer wall surface facing an outer surface of the disc 50 and an outer circumferential surface facing the outer circumferential surface of the disc 50. The first filter housing 410 and the second filter housing 420 may be coupled to each other to form a body such as a single piece body in which the filter module 200 is accommodated and supported and formed in a shape of surrounding or covering at least a part of an inner surface, an outer surface, and an outer circumferential surface of the disc 50.

The first filter housing 410 and the second filter housing 420 may be substantially arc-shaped and may have a shape substantially corresponding to a shape of the disc 50, and the first filter housing 410 and the second filter housing 420 may be formed to extend in the radial direction of the disc 50 and extend or expand to cover a leading part and a trailing part side of the caliper housing 20, wherein the trailing part is an end part of the caliper housing 20 towards the rotating direction of the disc 50 and leading part is an opposite end part of the caliper housing 20. Accordingly, the caliper brake can be safely covered, and a space in which the filter module 200 is mounted can expand to more effectively capture dust. The first filter housing 410 and the second filter housing 420 may be coupled to each other using any means for example, but not limited to, a fastener such as a bolt or the like and mounted on or to the vehicle body through the first filter housing 110 fixed to a fixing part of the vehicle body, a fixture or a part of the vehicle or a body of the vehicle.

At least any one of the first filter housing 410 and the second filter housing 420 may include a maintenance hole 470 through which one portion of the caliper housing 20 is exposed outside at least any one of the first filter housing 410 and the second filter housing 420. As described above, in the caliper brake, various components such as a pressing member such as a piston installed to move forward or backward, a bolt which couples the caliper housing 20 and an actuator, and a guide rod which movably couples the caliper housing 20 and a carrier may be installed in the caliper housing 20, and the maintenance hole 470 may be formed to pass through any one of the filter housings 410 and 420 so that the caliper brake can be maintained without dissembling the filter housing 400 through the maintenance hole 470 when the caliper brake is failed or checked. In FIG. 12, it is illustrated that the maintenance hole 470 is provided in the first filter housing 410, but a plurality of maintenance holes 470 may be provided in various portions in the first filter housing 410 and/or the second filter housing 420 as long as it is adjacent to components that are frequently replaced and checked.

A caliper brake according to some embodiments of the present disclosure can stably capture dust caused or generated by friction between a disc and a brake pad.

A caliper brake according to certain embodiments of the present disclosure can suppress and minimize external spread of dust caused or generated by friction between a disc and a brake pad.

A caliper brake according to some embodiments of the present disclosure can improve the easiness of maintenance because a filter module is detachably attached to the caliper brake.

A caliper brake according to certain embodiments of the present disclosure can improve the marketability and competitiveness of a vehicle.

A caliper brake according to some embodiments of the present disclosure may have a simple structure so that productivity and assembly of a product can be improved.

What is claimed is:

1. A caliper brake including a disc configured to be rotatable with a wheel and at least one brake pad, the caliper brake comprising:
a caliper housing, wherein at least a part of the brake pad is disposed in the caliper housing and the caliper housing covers at least a part of the disc; and
a dust capturing device configured to capture dust from the brake pad, the dust capturing device including a filter housing disposed to cover at least a part of an outer circumferential surface of the disc and a filter module coupled to the filter housing.

2. The caliper brake of claim 1, wherein the filter module is snap-coupled to the filter housing.

3. The caliper brake of claim 2, wherein the filter module includes:
a filter member comprising a filter; and
a cage in which the filter member comprising the filter is supported.

4. The caliper brake of claim 3, wherein:
the filter module has at least one clip protruding from the cage; and
the filter housing has a clip groove recessed from a surface of the filter housing such that the clip of the filter module is inserted into the clip groove of the filter housing to couple the filter module and the filter housing.

5. The caliper brake of claim 4, wherein:
the clip of the filter module protrudes from a side end portion of the cage; and
the clip groove of the filter housing is recessed from a side end portion of the filter housing.

6. The caliper brake of claim 5, wherein the filter module is snap-coupled to a filter accommodation part of the filter housing, and the filter accommodation part is formed to be recessed in or pass through a central portion of the filter housing.

7. The caliper brake of claim 3, wherein the cage of the filter module has a plurality of holes for air flow.

8. The caliper brake of claim 3, wherein:
the cage of the filter module includes a first cage part forming an outer side surface of the cage in a radial direction of the disc and a second cage part forming an inner side surface of the cage in the radial direction of the disc; and
the filter member comprising the filter is disposed between the first cage part and the second cage part.

9. The caliper brake of claim 8, wherein the first cage part and the second cage part are snap-coupled.

10. The caliper brake of claim 9, wherein:
one of the first cage part and the second cage part has at least one cage clip protruding from a surface of the one of the first cage part and the second cage part; and
an other of the first cage part and the second cage part has a cage clip groove recessed from a surface of the other of the first cage part and the second cage part such that the cage clip is inserted into the cage clip groove to couple the filter cage part and the second cage part.

11. The caliper brake of claim 8, wherein the first cage part and the second cage part have a plurality of holes for air flow.

12. The caliper brake of claim 1, wherein:
the filter housing is supported by a fixing part of a vehicle body including a knuckle.

13. The caliper brake of claim 12, wherein:
the filter housing includes a first filter housing and a second filter housing;
at least a part of the first filter housing is disposed inside the vehicle body and at least a part of the second filter housing is disposed outside the vehicle body; and
the first filter housing and the second filter housing are formed to extend toward a leading part and a trailing part of the caliper housing.

14. The caliper brake of claim 13, wherein at least one of the first filter housing and the second filter housing includes a maintenance hole formed to be open such that a part of an outer surface of the caliper housing is exposed outside the filter housing.

15. The caliper brake of claim 1, wherein the filter module is provided as a plurality of filter modules.

16. The caliper brake of claim 1, wherein the filter module and the filter housing have a slide-coupling to be coupled to each other.

17. The caliper brake of claim 16, wherein the filter module includes:
a filter member comprising a filter; and
a cage in which the filter member comprising the filter is supported.

18. The caliper brake of claim 17, wherein:
the cage of the filter module includes a slide groove recessed from a surface of the cage, and
the filter housing comprises a filter accommodation part having an edge inserted in the slide groove of the cage of the filter module.

19. The caliper brake of claim 18, wherein:
the filter housing includes a first filter housing and a second filter housing;
at least a part of the first filter housing is disposed inside a vehicle body and at least a part of the second filter housing is disposed outside the vehicle body;
the filter accommodation part is formed at the first filter housing and the second filter housing;
at least a part of the slide groove of the cage of the filter module is coupled to an edge of the filter accommodation part formed at one or both of the first filter housing and the second filter housing.

20. The caliper brake of claim 18, wherein the slide groove of the cage of the filter module is formed to extend in an axial direction of the disc.
